(19) United States
(12) Patent Application Publication
(10) Pub. No.: US 2025/0173552 A1
(43) Pub. Date: May 29, 2025

(54) LEARNING DEVICE, LEARNING METHOD, AND TEST DEVICE AND TEST METHOD USING SAME

(71) Applicants: HYUNDAI MOTOR COMPANY, Seoul (KR); Kia Corporation, Seoul (KR); Korea Advanced Institute of Science and Technology, Daejeon (KR)

(72) Inventors: Sung Hun JOUNG, Seoul (KR); Kuk Jin YOON, Daejeon (KR); Jae Woo JEONG, Daejeon (KR); Ji Hun KIM, Daejeon (KR)

(73) Assignees: HYUNDAI MOTOR COMPANY, Seoul (KR); Kia Corporation, Seoul (KR); Korea Advanced Institute of Science and Technology, Daejeon (KR)

(21) Appl. No.: 18/789,314

(22) Filed: Jul. 30, 2024

(30) Foreign Application Priority Data
Nov. 28, 2023 (KR) 10-2023-0168434

(51) Int. Cl. G06N 3/0455; G01S 7/48; G01S 17/42; G01S 17/89; G06N 3/084

(52) U.S. Cl. CPC G06N 3/0455; G01S 7/4808; G01S 17/42; G01S 17/89; G06N 3/084

(57) ABSTRACT

In a learning device and learning method, and a test device and a test method using the same, the learning device includes an encoder that outputs a main encoding feature, and a peripheral encoding, a cylindrical feature mapping device that maps the main encoding feature and the peripheral encoding feature to a first cylindrical shell to a n-th cylindrical shell, and outputs an integrated shell feature including a main feature and a peripheral feature, a cylindrical transformer that updates the integrated shell feature by modifying a value of the main feature with reference to the peripheral feature, a decoder that outputs predicted main depth information, and a parameter update device, that is configured to determine a first loss, and updates at least some of parameters of the encoder, the cylindrical feature mapping device, the cylindrical transformer, and the-decoder by use of the first loss.

### CROSS-REFERENCE TO RELATED APPLICATION

The present application claims priority to Korean Patent Application No. 10-2023-0168434, filed on Nov. 28, 2023, the entire contents of which is incorporated herein for all purposes by this reference.

### BACKGROUND OF THE PRESENT DISCLOSURE

### Field of the Present Disclosure

The present disclosure relates to a learning device, a learning method, and a test device and a test method using the same.

### Description of Related Art

Recently, as autonomous driving technology has developed rapidly, a need to accurately detect three-dimensional (3D) spatial information (depth information, and the like) based on a vehicle has emerged.

In the past, there was a scheme that utilizes a Light Detection and Ranging (LiDAR) sensor as one of schemes of obtaining 3D spatial information. However, due to the excessively high price, it is difficult for LiDAR sensors to be widely provided in commercial vehicles. Furthermore, it is difficult to obtain dense 3D spatial information due to the limitation of the number of channels of a LiDAR sensor.

Meanwhile, images obtained from image sensors generally have a very large number of pixels, so when 3D spatial information is estimated for each pixel of the image, the 3D spatial information is denser than the point cloud information of the LiDAR sensor. Furthermore, image sensors are much cheaper than LiDAR sensors and are provided in most vehicles.

Therefore, methods for estimating 3D spatial information based on image sensors have been studied.

The information included in this Background of the present disclosure is only for enhancement of understanding of the general background of the present disclosure and may not be taken as an acknowledgement or any form of suggestion that this information forms the prior art already known to a person skilled in the art.

### BRIEF SUMMARY

Various aspects of the present disclosure are directed to providing a learning device and learning method capable of estimating 3D spatial information based on a plurality of image sensors, and a test device and a test method using the same.

Another aspect of the present disclosure provides a learning device and learning method capable of estimating omnidirectional 3D spatial information, and a test device and a test method using the same.

Yet another aspect of the present disclosure provides a learning device and learning method capable of estimating accurate 3D spatial information by use of temporal information and spatial information, and a test device and testing method using the same.

The technical problems to be solved by the present disclosure are not limited to the aforementioned problems, and any other technical problems not mentioned herein will be clearly understood from the following description by those skilled in the art to which the present disclosure pertains.

According to an aspect of the present disclosure, a learning device includes a memory that stores computer-executable instructions, and at least one processor that accesses the memory and executes the instructions, wherein the at least one processor may output, through an encoder, a main encoding feature corresponding to a main image at a t-th time point obtained from a main image sensor, and output a peripheral encoding feature corresponding to at least one peripheral image which is obtained from a peripheral image sensor at the t-th time point and includes at least a part of a view angle overlapping the main image, map, through a cylindrical feature mapping device, the main encoding feature and the peripheral encoding feature to a first cylindrical shell to a n-th cylindrical shell corresponding to a first depth value to a n-th depth value, and output an integrated shell feature including a main feature corresponding to the main image at the t-th time point and a peripheral feature corresponding to the peripheral image at the t-th time point with reference to a mapping result, update the integrated shell feature by modifying a value of the main feature with reference to the peripheral feature through a cylindrical transformer, output, through a decoder, predicted main depth information corresponding to the main image at the t-th time point with reference to the updated integrated shell feature, and determine, through a parameter update device, a first loss with reference to the predicted main depth information and ground truth (GT) main depth information corresponding to the predicted main depth information, and update at least some of parameters of the encoder, the cylindrical feature mapping device, the cylindrical transformer, and the decoder by use of the first loss.

According to an exemplary embodiment of the present disclosure, the at least one processor may additionally determine a second loss with reference to predicted main depth information corresponding to a main image at at least one of a (t+1)-th time point and a (t−1)-th time point and the predicted main depth information corresponding to the main image at the t-th time point, and update at least some of parameters of the encoder, the cylindrical feature mapping device, the cylindrical transformer, and the decoder by additionally using the second loss through the parameter update device.

According to an exemplary embodiment of the present disclosure, the cylindrical feature mapping device may include a feature output device and a reliability output device, wherein the at least one processor may output, through the feature output device, a first shell feature to a n-th shell feature corresponding to the first cylindrical shell to the n-th cylindrical shell by applying a feature extraction operation to a mapping result in the first cylindrical shell to the n-th cylindrical shell, output, through the reliability output device, first shell reliability to n-th shell reliability corresponding to the first cylindrical shell to the n-th cylindrical shell by applying a reliability extraction operation to the mapping result in the first cylindrical shell to the n-th cylindrical shell, and output, through the cylindrical feature mapping device, the integrated shell feature with reference to the first shell feature to the n-th shell feature and the first shell reliability to the n-th shell reliability corresponding to the first shell feature to the n-th shell feature.

According to an exemplary embodiment of the present disclosure, the at least one processor is configured to output the integrated shell feature by applying a weighted sum operation to the first shell feature to the n-th shell feature and the first shell reliability to the n-th shell reliability corresponding to the first shell feature to the n-th shell feature through the cylindrical feature mapping device.

According to an exemplary embodiment of the present disclosure, the cylindrical transformer may include a query network and a neighbor network, wherein the at least one processor is configured to output a first query corresponding to the main feature through the query network, output a first key and a first value corresponding to the peripheral feature through the neighbor network, and update the integrated shell feature by modifying the value of the main feature with reference to the first query, the first key, and the first value through the cylindrical transformer.

According to an exemplary embodiment of the present disclosure, the at least one processor may additionally output a second query corresponding to the peripheral feature through the query network, additionally output a second key and a second value corresponding to the main feature through the neighbor network, and update the integrated shell feature by additionally modifying a value of the peripheral feature with additional reference to the second query, the second key, and the second value through the cylindrical transformer.

According to an exemplary embodiment of the present disclosure, the at least one processor may additionally output, through the decoder, predicted peripheral depth information corresponding to the peripheral image at the t-th time point with reference to the updated integrated shell feature, and determine the first loss with additional reference to the predicted peripheral depth information and GT peripheral depth information corresponding to the predicted peripheral depth information through the parameter update device.

According to an exemplary embodiment of the present disclosure, the GT main depth information may be generated using point cloud information obtained from LiDAR sensor, an external parameter corresponding to the LiDAR sensor and the main image sensor, and an internal parameter corresponding to the main image sensor.

According to another aspect of the present disclosure, a test device includes a memory that stores computer-executable instructions, and at least one processor that accesses the memory and executes the instructions, wherein the at least one processor may output, through an encoder, a main encoding feature for testing corresponding to a main image for testing at a predetermined time point obtained from a main image sensor, and output a peripheral encoding feature for testing corresponding to at least one peripheral image for testing which is obtained from a peripheral image sensor at the predetermined time point and includes at least a part of a view angle overlapping the main image for testing, map, through a cylindrical feature mapping device, the main encoding feature for testing and the peripheral encoding feature for testing to a first cylindrical shell to a n-th cylindrical shell corresponding to a first depth value to a n-th depth value, and output an integrated shell feature for testing including a main feature for testing corresponding to the main image for testing and a peripheral feature for testing corresponding to the peripheral image for testing with reference to a mapping result, update the integrated shell feature by modifying a value of the main feature for testing with reference to the peripheral feature for testing through a cylindrical transformer, and output, through a decoder, predicted main depth information corresponding to the main image for testing with reference to the updated integrated shell feature for testing.

According to an exemplary embodiment of the present disclosure, the cylindrical feature mapping device may include a feature output device and a reliability output device, wherein the at least one processor may output, through the feature output device, a first shell feature for testing to a n-th shell feature for testing corresponding to the first cylindrical shell to the n-th cylindrical shell by applying a feature extraction operation to a mapping result in the first cylindrical shell to the n-th cylindrical shell, output, through the reliability output device, first shell reliability for testing to n-th shell reliability for testing corresponding to the first cylindrical shell to the n-th cylindrical shell by applying a reliability extraction operation to the mapping result in the first cylindrical shell to the n-th cylindrical shell, and output, through the cylindrical feature mapping device, the integrated shell feature for testing with reference to the first shell feature for testing to the n-th shell feature for testing and the first shell reliability for testing to the n-th shell reliability for testing corresponding to the first shell feature for testing to the n-th shell feature for testing.

According to yet another aspect of the present disclosure, a learning method includes outputting a main encoding feature corresponding to a main image at a t-th time point obtained from a main image sensor, and outputting a peripheral encoding feature corresponding to at least one peripheral image which is obtained from a peripheral image sensor at the t-th time point and includes at least a part of a view angle overlapping the main image, mapping the main encoding feature and the peripheral encoding feature to a first cylindrical shell to a n-th cylindrical shell corresponding to a first depth value to a n-th depth value, and outputting an integrated shell feature including a main feature corresponding to the main image at the t-th time point and a peripheral feature corresponding to the peripheral image at the t-th time point with reference to a mapping result, updating the integrated shell feature by modifying a value of the main feature with reference to the peripheral feature through a cylindrical transformer, outputting predicted main depth information corresponding to the main image at the t-th time point with reference to the updated integrated shell feature, and determining a first loss with reference to the predicted main depth information and ground truth (GT) main depth information corresponding to the predicted main depth information, and back-propagating the first loss.

According to an exemplary embodiment of the present disclosure, the back-propagating of the first loss may include additionally determining a second loss with reference to predicted main depth information corresponding to a main image at at least one of a (t+1)-th time point and a (t−1)-th time point and the predicted main depth information corresponding to the main image at the t-th time point, and additionally back-propagating the second loss.

According to an exemplary embodiment of the present disclosure, the outputting of the integrated shell feature may include outputting a first shell feature to a n-th shell feature corresponding to the first cylindrical shell to the n-th cylindrical shell by applying a feature extraction operation to a mapping result in the first cylindrical shell to the n-th cylindrical shell, outputting first shell reliability to n-th shell reliability corresponding to the first cylindrical shell to the n-th cylindrical shell by applying a reliability extraction operation to the mapping result in the first cylindrical shell to the n-th cylindrical shell, and outputting the integrated shell feature with reference to the first shell feature to the n-th shell feature and the first shell reliability to the n-th shell reliability corresponding to the first shell feature to the n-th shell feature.

According to an exemplary embodiment of the present disclosure, the outputting of the integrated shell feature may include outputting the integrated shell feature by applying a weighted sum operation to the first shell feature to the n-th shell feature and the first shell reliability to the n-th shell reliability corresponding to the first shell feature to the n-th shell feature.

According to an exemplary embodiment of the present disclosure, the updating of the integrated shell feature may include outputting a first query corresponding to the main feature, outputting a first key and a first value corresponding to the peripheral feature, and modifying the value of the main feature with reference to the first query, the first key, and the first value.

According to an exemplary embodiment of the present disclosure, the updating of the integrated shell feature may include outputting a second key and a second value corresponding to the main feature, outputting a second query corresponding to the peripheral feature, and modifying a value of the peripheral feature with reference to the second query, the second key, and the second value.

According to an exemplary embodiment of the present disclosure, the outputting of the predicted main depth information may include additionally outputting predicted peripheral depth information corresponding to the peripheral image at the t-th time point with reference to the updated integrated shell feature, wherein the back-propagating of the first loss may include determining the first loss with additional reference to the predicted peripheral depth information and ground truth (GT) main depth information corresponding to the predicted peripheral depth information.

The methods and apparatuses of the present disclosure have other features and advantages which will be apparent from or are set forth in more detail in the accompanying drawings, which are incorporated herein, and the following Detailed Description, which together serve to explain certain principles of the present disclosure.

### BRIEF DESCRIPTION OF THE DRAWINGS

FIG. 1 is a block diagram illustrating the configuration of a learning device according to an exemplary embodiment of the present disclosure;

FIG. 2, FIG. 3 and FIG. 4 are diagrams illustrating the operation of a learning device according to an exemplary embodiment of the present disclosure;

FIG. 5 is a flowchart illustrating a learning method according to an exemplary embodiment of the present disclosure;

FIG. 6 is a block diagram illustrating the configuration of a test device according to an exemplary embodiment of the present disclosure; and

FIG. 7 is a block diagram illustrating a determining system for executing a method of outputting depth information according to an exemplary embodiment of the present disclosure.

It may be understood that the appended drawings are not necessarily to scale, presenting a somewhat simplified representation of various features illustrative of the basic principles of the present disclosure. The predetermined design features of the present disclosure as included herein, including, for example, specific dimensions, orientations, locations, and shapes will be determined in part by the particularly intended application and use environment.

In the figures, reference numbers refer to the same or equivalent portions of the present disclosure throughout the several figures of the drawing.

### DETAILED DESCRIPTION

Reference will now be made in detail to various embodiments of the present disclosure(s), examples of which are illustrated in the accompanying drawings and described below. While the present disclosure(s) will be described in conjunction with exemplary embodiments of the present disclosure, it will be understood that the present description is not intended to limit the present disclosure(s) to those exemplary embodiments of the present disclosure. On the other hand, the present disclosure(s) is/are intended to cover not only the exemplary embodiments of the present disclosure, but also various alternatives, modifications, equivalents and other embodiments, which may be included within the spirit and scope of the present disclosure as defined by the appended claims.

Hereinafter, various embodiments of the inventive concept will be described in detail with reference to the accompanying drawings, so that those skilled in the art can easily carry out the inventive concept. However, the inventive concept is not limited to the exemplary embodiments set forth herein and may be modified variously in various forms.

In describing the exemplary embodiments of the present specification, when a predetermined Description of Related Art is deemed to obscure the subject matter of the exemplary embodiments of the present specification, the detailed description will be omitted. In the drawings, the portions irrelevant to the description will not be shown to make the present disclosure clear.

It will be understood that when an element is referred to as being “connected” or “coupled” to another element, it may be directly connected or indirectly connected to another element. Furthermore, when some portion ‘includes’ or “has” some elements, unless explicitly described to the contrary, it means that other elements may be further included but not excluded.

Expressions such as “first,” or “second,” and the like, may express their elements regardless of their priority or importance and may be used to distinguish one element from another element but is not limited to these components. Therefore, without departing from the scope of the present disclosure, a first component of various exemplary embodiments of the present disclosure may be referred to as a second component of another exemplary embodiment of the present disclosure. Similarly, a second component of various exemplary embodiments of the present disclosure may be referred to as a first component of another exemplary embodiment of the present disclosure.

In an exemplary embodiment of the present disclosure, components that are distinguished from each other are only for clearly describing characteristics, and do not mean that the components are necessarily separated. That is, a plurality of components may be integrated to form a single hardware or software unit, or a single component may be distributed to form a plurality of hardware or software units. Accordingly, such integrated or distributed embodiments are included in the scope of the present disclosure, even though not mentioned separately.

In an exemplary embodiment of the present disclosure, components described In various embodiments do not necessarily mean essential components, and some may be optional components. Therefore, an exemplary embodiment including a subset of components described in an exemplary embodiment of the present disclosure is also included in the scope of the present disclosure. Furthermore, various exemplary embodiments including other components in addition to the components described in various exemplary embodiments of the present disclosure are also included in the scope of the present disclosure.

In an exemplary embodiment of the present disclosure, expressions of positional relationships used herein, such as upper, lower, left, right, and the like, are described for convenience of description. When viewing the drawings shown in the present specification in reverse, the positional relationship described in the specification may be interpreted in the opposite manner.

As used herein, each of such phrases as “A or B,” “at least one of A and B,” “at least one of A or B,” “A, B, or C,” “at least one of A, B, and C,” and “at least one of A, B, or C,” may include any one of, or all possible combinations of the items enumerated together in a corresponding one of the phrases.

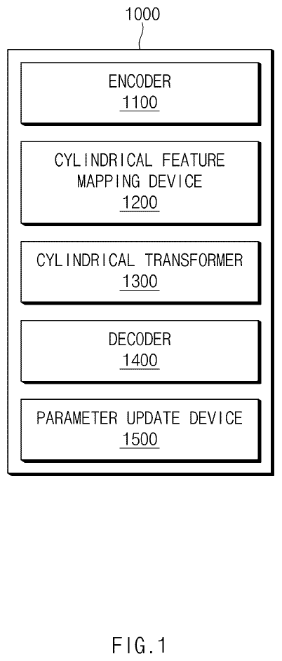

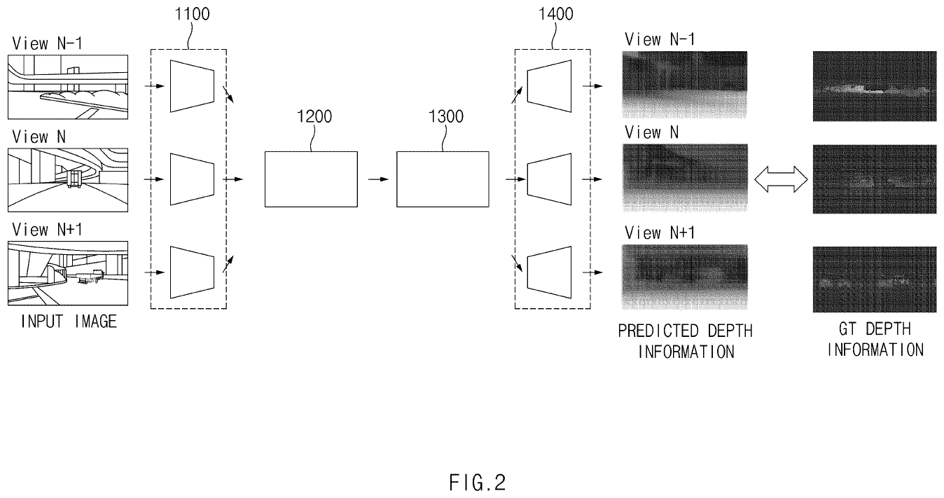

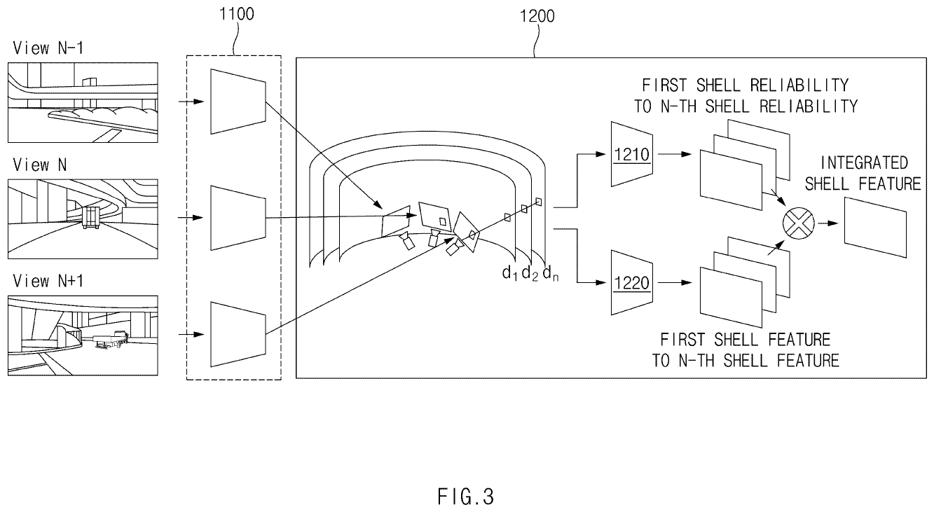

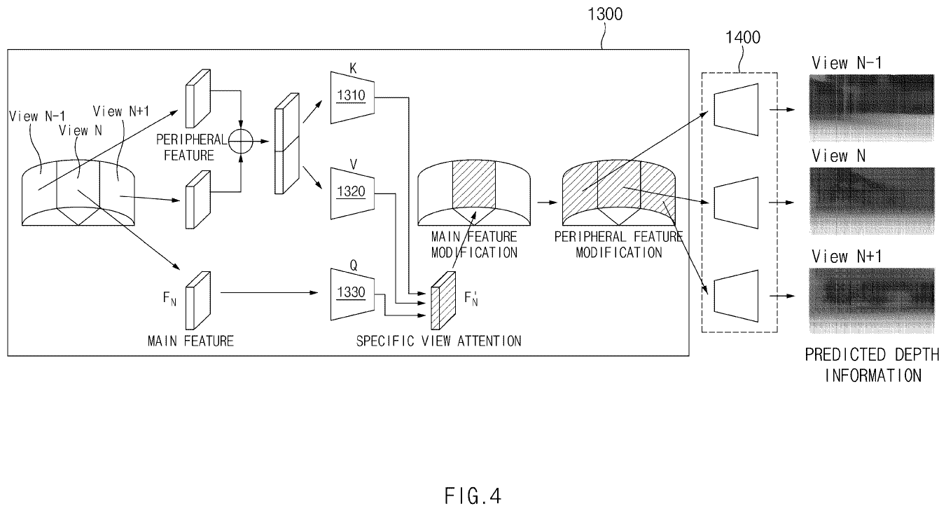

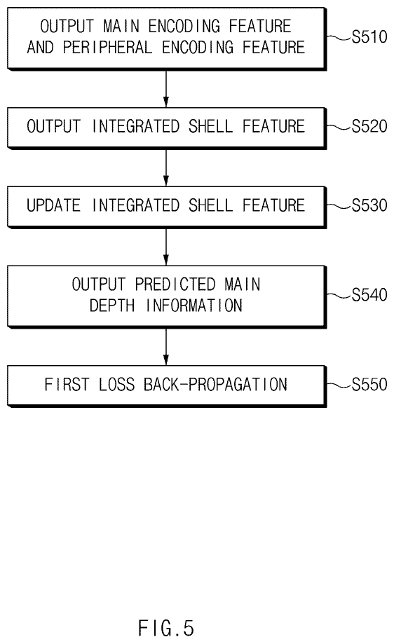

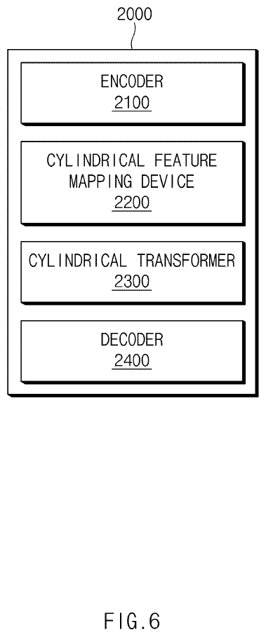

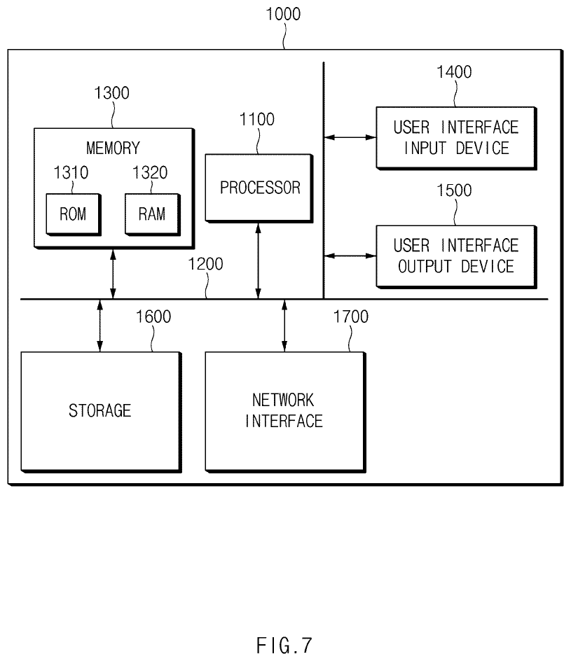

Hereinafter, various exemplary embodiments of the present disclosure will be described in detail with reference to FIG. 1, FIG. 2, FIG. 3, FIG. 4, FIG. 5, FIG. 6, FIG. 7, FIG. 8 and FIG. 9.

FIG. 1 is a block diagram illustrating the configuration of a learning device 1000 according to an exemplary embodiment of the present disclosure.

Referring to FIG. 1, the learning device 1000 may include an encoder 1100, a cylindrical feature mapping device 1200, a cylindrical transformer 1300, a decoder 1400, and a parameter update device 1500.

Hereinafter, the operation of a learning device according to an exemplary embodiment of the present disclosure will be described in more detail with reference to FIG. 1 and FIG. 2.

First, the encoder 1100 may output a main encoding feature corresponding to a main image (View N) at a t-th time point obtained from a main image sensor.

Furthermore, the encoder 1100 may output a peripheral encoding feature corresponding to at least one peripheral image (View N−1 and View N+1) which is obtained from a peripheral image sensor at the t-th time point and includes at least a part of a view angle overlapping the main image. For reference, FIG. 2 illustrates two peripheral images for convenience, but the exemplary embodiments are not limited thereto. For example, there may be one peripheral image, or three peripheral images or more. For convenience of explanation, FIG. 2 and FIG. 3 and FIG. 4 to be described later illustrate two peripheral images obtained from two peripheral image sensors.

In the instant case, the encoder 1100 may be ResNet34. However, the encoder 1100 according to an exemplary embodiment of the present disclosure is not limited to ResNet34, and may be another network that is configured to perform a convolution operation.

For reference, the distinction between the main image sensor and the peripheral image sensor is unrelated to the performance of an image sensor. That is, when a k-th image sensor among a first image sensor to an m-th image sensor is defined as the main image sensor, at least one image sensor whose angle of view at least partially overlaps with the k-th image sensor among the remaining image sensors may be defined as the peripheral image sensor.

For example, when it is assumed that a first image sensor to a sixth image sensor are mounted on a vehicle to face the front, front side (right), rear side (right), rear, rear side (left), and front side (left) of the vehicle, and the first image sensor that detects the front of the vehicle is defined as the main image sensor, the sixth image sensor (front side (left)) and the second image sensor (front side (right)) whose angles of view partially overlap with the first image sensor may be defined as peripheral image sensors.

Furthermore, the cylindrical feature mapping device 1200 may map a main encoding feature and a peripheral encoding feature to a first cylindrical shell to a n-th cylindrical shell corresponding to a first depth value to a n-th depth value, and may output an integrated shell feature including a main feature corresponding to the main image at the t-th time point and a peripheral feature corresponding to the peripheral image at the t-th time point with reference to mapping results in the first cylindrical shell to the n-th cylindrical shell.

In an exemplary embodiment of the present disclosure, the encoder 1100, the cylindrical feature mapping device 1200, the cylindrical transformer 1300, the decoder 1400, and the parameter update device 1500 may be implemented by at least a processor (e.g., computer, microprocessor, CPU, ASIC, circuitry, logic circuits, etc.).

Hereinafter, the operation of the cylindrical feature mapping device 1200 will be described with additional reference to FIG. 3.

Referring to FIG. 3, the cylindrical feature mapping device 1200 may include a feature output device 1220 and a reliability output device 1210. For reference, the feature output device 1220 and the reliability output device 1210 may be models that perform a convolution operation.

First, the cylindrical feature mapping device 1200 may map the main encoding feature and the peripheral encoding feature to a cylindrical coordinate system.

As an exemplary embodiment of the present disclosure, the cylindrical feature mapping device 1200 may map a main encoding feature to an area corresponding to the main encoding feature on the first cylindrical shell corresponding to a first depth value d₁ to the n-th cylindrical shell corresponding to a n-th depth value dₙ. Furthermore, the cylindrical feature mapping device 1200 may map a peripheral encoding feature to an area corresponding to peripheral images on the first cylindrical shell corresponding to the first depth value d₁ to the n-th cylindrical shell corresponding to the n-th depth value dₙ.

Furthermore, the feature output device 1220 may output the first shell feature to the n-th shell feature corresponding to the first cylindrical shell to the n-th cylindrical shell by applying a feature extraction operation to mapping results in the first cylindrical shell to the n-th cylindrical shell. For example, the feature extraction operation may be applied to the main encoding feature and the peripheral encoding feature mapped to each pixel of the k-th cylindrical shell, and the k-th shell feature may be output. The k-th shell feature generated in such a manner may have information related to the k-th depth value dk.

Meanwhile, the reliability output device 1210 may output first shell reliability to n-th shell reliability corresponding to the first cylindrical shell to the n-th cylindrical shell by applying a reliability extraction operation to the mapping results in the first cylindrical shell to the n-th cylindrical shell. For example, the reliability extraction operation may be applied to the main encoding feature and the peripheral encoding feature mapped to each pixel of the k-th cylindrical shell, and the k-th shell reliability may be output. The k-th shell reliability generated in such a manner may be the reliability of each pixel of the k-th depth value dx of the k-th cylindrical shell.

For example, it is assumed that the actual depth value at specific coordinates on the main image is 20 m, and that the depth value of dₙ among the depth values of d₁ to dₙ is equal/similar to 20 m. In the instant case, the reliability output device may learn in the direction in which the shell reliability is output so that the reliability value, which corresponds to the specific coordinates (pixel) in the n-th shell reliability among the first shell reliability to the n-th shell reliability, includes a higher value than the reliability value corresponding to the specific coordinates in the first shell reliability to the (n−1)-th shell reliability.

Furthermore, the cylindrical feature mapping device 1200 may output the integrated shell feature with reference to the first shell feature to the n-th shell feature and the corresponding first to n-th shell reliability.

For example, the cylindrical feature mapping device 1200 may output the integrated shell feature by applying a weighted sum operation to the first shell feature to the n-th shell feature and the corresponding first to n-th shell reliability.

For example, after repeatedly performing the process of multiplying the feature value corresponding to specific coordinates in the k-th shell feature and the reliability value corresponding to specific coordinate in the k-th shell reliability for all coordinates of the first shell to the n-th shell, the cylindrical feature mapping device 1200 may output the integrated shell feature by summing the multiplication values of the same coordinates in the entire shell.

For reference, for convenience, FIG. 3 and FIG. 4, which will be described later, illustrate the integrated shell feature which is generated by use of only the main encoding feature from the main image and the peripheral encoding feature from the peripheral image, but the exemplary embodiments are not limited thereto.

For example, when it is assumed that the first image sensor to the sixth image sensor are mounted on the vehicle to face the front, front side (right), rear side (right), rear, rear side (left), and front side (left) of the vehicle, and the first image sensor that detects the front of the vehicle is defined as the main image sensor, as well as (i) images (i.e., peripheral images) from the sixth image sensor (front side (left)) and the second image sensor (front side (right)) whose angle of view partially overlaps with the first image sensor, (ii) images from the third image sensor (rear side (right)) to the fifth image sensor (rear side (left)) whose angle of view do not overlap with the first image sensor may be used to generate the integrated shell feature.

Furthermore, the cylindrical transformer 1300 may update the integrated shell feature by modifying the value of the main feature with reference to the peripheral features.

Hereinafter, the operation of the cylindrical transformer 1300 will be described with additional reference to FIG. 4.

Referring to FIG. 4, the cylindrical transformer 1300 may include a query network 1330 and neighbor networks 1310 and 1320. For example, the query network 1330 and the neighbor networks 1310 and 1320 may be multilayer perceptrons.

For example, the query network 1330 may receive a main feature Fₙ corresponding to the main image among integrated shell features and output a first query Q corresponding thereto.

Furthermore, the neighbor networks 1310 and 1320 may receive neighboring features among integrated shell features and output a first key K and a first value V corresponding thereto.

Furthermore, the cylindrical transformer 1300 may modify the value of the main feature with reference to the first query Q, the first key K, and the first value V.

For example, the cylindrical transformer 1300 may modify the value of the main feature with the value derived by applying a scaled dot-product attention scheme to the first query Q, the first key K, and the first value V.

For example, referring to FIG. 4, the cylindrical transformer 1300 may (i) receive the main feature F_{N} corresponding to the main image among the integrated shell features through the query network 1330 and output the first query Q, (ii) receive a peripheral feature corresponding to a peripheral image among the integrated shell features through the neighbor networks 1310 and 1320, and output the first key K and the first value V, (iii) apply the scaled dot-product attention scheme to the first query Q, the first key K, and the first value V and derive the modified main feature (specific view attention) F′_{N}, and (iv) update the integrated shell feature by applying the modified main feature F′_{N} to the integrated shell feature.

For reference, the cylindrical transformer 1300 may apply the scaled dot-product attention scheme to the first query Q, the first key K, and the first value V according to following Equation 1 and derive the modified main feature F′_{N}.

$${F}_{N}^{′} = softmax ( \frac{Q \cdot K}{\sqrt{c}} ) \cdot V \qquad [ Equation 1 ]$$

For reference, ‘c’ corresponds to the feature dimension of the key.

Furthermore, as shown in FIG. 4, the cylindrical transformer 1300 may repeatedly perform a modification process similar to the above-described main feature on peripheral features. That is, the cylindrical transformer 1300 may repeat the process of modifying the features corresponding to each image (view) by utilizing information related to the overlapping area between a plurality of images obtained through a plurality of image sensors, updating the integrated shell feature.

For example, the cylindrical transformer 1300 may repeatedly perform the process of modifying the main feature value (where k is 1 to m) by use of the k-th image sensor among the first image sensor to the m-th image sensor as the main image sensor, and the (k−1)-th image sensor and/or the (k+1)-th image sensor as the peripheral image sensors to update the integrated shell feature.

For example, the cylindrical transformer 1300 may (i) receive a peripheral feature corresponding to a peripheral image among the integrated shell features through the query network 1330 and output a second query Q corresponding thereto, (ii) receive a main feature corresponding to the main image among the integrated shell features through the neighbor networks 1310 and 1320 and output a second key K and a second value V corresponding thereto, (iii) derive modified peripheral features by applying the scaled dot-product attention scheme to the second query Q, the second key K, and the second value V, and (iv) update the integrated shell feature by applying the modified peripheral features to the integrated shell feature.

For reference, in FIG. 4, because there are two peripheral images (i.e., a peripheral image (View N−1) overlapping with the left angle of view of the main image (View N) and a peripheral image (View N+1) overlapping with the right angle of view of the main image (View N)), for convenience of determination, two peripheral features corresponding to view N−1 and view N+1 are shown as concatenation, but the exemplary embodiments are not limited thereto. For example, when there is one peripheral image, the neighbor network may output the key K and the value V from the peripheral feature corresponding to the peripheral image without performing a concatenation operation.

The decoder 1400 may output predicted main depth information corresponding to the main image at time t by referring to the updated integrated shell feature. Similarly, the decoder 1400 may additionally output predicted peripheral depth information corresponding to the peripheral image at time t by referring to the updated integrated shell feature.

For example, the decoder 1400 may output predicted main depth information with reference to a feature (i.e., modified main feature) corresponding to the main image (View N) at the t-th time point among the updated integrated shell features, and may output predicted peripheral depth information with reference to features (i.e., modified peripheral features) corresponding to the peripheral images (View N−1 and View N+1) at the t-th time point among the updated integrated shell features.

Accordingly, the decoder 1400 may output predicted depth information for all directions corresponding to each of the image sensors. For reference, the decoder 1400 may be a model that is configured to perform a convolution operation.

Furthermore, the parameter update device 1500 may be configured to determine a first loss with reference to predicted main depth information and ground truth (GT) main depth information corresponding to the predicted main depth information, and use the first loss to update at least some of the parameters of the encoder 1100, the cylindrical feature mapping device 1200, the cylindrical transformer 1300, and the decoder 1400. In the instant case, the parameter update device 1500 may be configured to determine the first loss with additional reference to the predicted peripheral depth information and the corresponding GT peripheral depth information.

For reference, the GT main depth information may be generated by use of (i) point cloud information obtained from the LiDAR sensor, (ii) external parameters corresponding to the LiDAR sensor and the main image sensor, and (iii) internal parameters corresponding to the main image sensor.

Similarly, the GT peripheral depth information may be generated by use of (i) point cloud information obtained from the LiDAR sensor, (ii) external parameters corresponding to the LiDAR sensor and the peripheral image sensor, and (iii) internal parameters corresponding to the peripheral image sensor.

For reference, because (i) a scheme of moving point cloud information to the camera coordinate system by use of external parameter information corresponding to an image sensor, and (ii) a scheme of moving point cloud information to the image coordinate system by use of external parameter information and internal parameter information corresponding to the image sensor are well-known in the art, the detailed description of the process of generating GT depth information corresponding to an image by use of point cloud information of a Light Detection and Ranging (LiDAR) sensor will be omitted.

Meanwhile, due to the characteristics of the LiDAR sensor, the depth information included in the point cloud information may not be dense, and accordingly, the depth information included in the GT main depth information and the GT peripheral depth information may be limited.

Therefore, an unsupervised learning method based on re-projection loss may be used together so that the encoder 1100, the cylindrical feature mapping device 1200, the cylindrical transformer 1300, and the decoder 1400 are learned based on richer depth information.

That is, based on the characteristics that the predicted depth information corresponding to an image obtained at a past time point and/or a future time point within a time interval close to the t-th time point and the predicted depth information corresponding to an image obtained at the t-th time point are similar to each other, at least some of the parameters of the encoder 1100, the cylindrical feature mapping device 1200, the cylindrical transformer 1300, and the decoder 1400 may be learned.

As an exemplary embodiment of the present disclosure, as a loss for updating parameters of at least some of the encoder 1100, the cylindrical feature mapping device 1200, the cylindrical transformer 1300, and the decoder 1400, (i) the first loss based on the images at the t-th time point, as described above, and (ii) the second loss based on the images at the t-th time point and peripheral time points (e.g., the (t−1)-th time point and/or the (t+1)-th time point), as described below may be used.

For reference, the (t−1)-th time point and the (t+1)-th time point each mean a specified past time point and a specified future time point set based on the t-th time point. For example, the (t−1)-th time point may be a past time point immediately before the t-th time point, but is not limited thereto, and may be a past time point that exists within a preset time interval from the t-th time point.

As an exemplary embodiment of the present disclosure, the parameter update device 1500 may additionally determine the second loss (e.g., a re-projection loss) with reference to the predicted main depth information corresponding to the main image at one of the (t+1)-th time point and the (t−1)-th time point and the predicted main image corresponding to the main image at the t-th time point, and may update at least some of the parameters of the encoder 1100, the cylindrical feature mapping device 1200, the cylindrical transformer 1300, and the decoder 1400 by additionally using the second loss.

FIG. 5 is a flowchart illustrating the operation of a learning device.

Referring to FIG. 5, in operation S510, the learning device may output a main encoding feature corresponding to a main image at the t-th time point obtained from a main image sensor, and output a peripheral encoding feature corresponding to at least one peripheral image at the t-th time point of which a view angle overlaps at least partially with the main image obtained from the peripheral image sensor.

Furthermore, in operation S520, the learning device may map the main encoding feature and the peripheral encoding feature to the first cylindrical shell to the n-th cylindrical shell corresponding to the first depth value to the n-th depth value, and output the integrated shell feature including the main feature corresponding to the main image at the t-th time point and the peripheral feature at the t-th time point with reference to the mapping result.

Furthermore, in operation S530, the learning device may update the integrated shell feature by modifying the value of the main feature with reference to the peripheral features.

Furthermore, in operation S540, the learning device may output predicted main depth information corresponding to the main image at the t-th time point with reference to the updated integrated shell feature.

In operation S550, the learning device may be configured to determine the first loss with reference to the predicted main depth information and the corresponding GT main depth information and back-propagate the first loss.

In an exemplary embodiment of the present disclosure, the back-propagating includes updating at least some of parameters of the encoder, the cylindrical feature mapping device, the cylindrical transformer, and the decoder.

Furthermore, the back-propagating the first loss includes additionally determining a second loss with reference to predicted main depth information corresponding to a main image at at least one of a (t+1)-th time point and a (t−1)-th time point and the predicted main depth information corresponding to the main image at the t-th time point, and additionally back-propagating the second loss.

Meanwhile, a test device 2000, which includes an encoder 2100, a cylindrical feature mapping device 2200, a cylindrical transformer 2300, and a decoder 2400 of which parameters are updated using the learning device 1000 described above, will be described below with reference to FIG. 6. For reference, descriptions that are the same as/similar to those of the learning device 1000 will be omitted.

In an exemplary embodiment of the present disclosure, the encoder 2100, the cylindrical feature mapping device 2200, the cylindrical transformer 2300, and the decoder 2400 may be implemented by at least a processor (e.g., computer, microprocessor, CPU, ASIC, circuitry, logic circuits, etc.).

FIG. 6 is a block diagram illustrating the configuration of the test device 2000 according to an exemplary embodiment of the present disclosure.

Referring to FIG. 6, the test device 2000 according to an exemplary embodiment of the present disclosure may include the encoder 1100, the cylindrical feature mapping device 1200, the cylindrical transformer 2300, and the decoder 2400.

For reference, because the parameter update device 1500 corresponds to the configuration required for the learning device 1000 to update at least some of the parameters of the encoder 2100, the cylindrical feature mapping device 2200, the cylindrical transformer 2300, and the decoder 2400, it may be confirmed that the test device 2000 does not include the parameter update device 1500 when compared to the configuration of the learning device 1000 shown in FIG. 1.

First, the encoder 2100 may output a main encoding feature for testing corresponding to a main image for testing at a predetermined time point obtained from a main image sensor, and may output a peripheral encoding feature for testing corresponding to at least one peripheral image for testing which is obtained from a peripheral image sensor at a specified time point and includes at least a part of a view angle overlapping the main image for testing.

Furthermore, the cylindrical feature mapping device 2200 may map the main encoding feature for testing and the peripheral encoding feature for testing to a first cylindrical shell to a n-th cylindrical shell corresponding to a first depth value to a n-th depth value, and output the integrated shell feature for testing including the main feature for testing corresponding to the main image for testing and the peripheral feature for testing corresponding to the peripheral image for testing with reference to the mapping result.

In the instant case, the cylindrical feature mapping device 2200 may include a feature output device and a reliability output device,

For example, the feature output device may output a first shell feature for testing to an n-th shell feature for testing corresponding to the first cylindrical shell to the n-th cylindrical shell by applying a feature extraction operation to the mapping result in the first cylindrical shell to the n-th cylindrical shell.

Furthermore, the reliability output device may output first shell reliability for testing to n-th shell reliability for testing corresponding to the first cylindrical shell to the n-th cylindrical shell by applying a reliability extraction operation to the mapping result in the first cylindrical shell to the n-th cylindrical shell.

Furthermore, the cylindrical feature mapping device 2200 may output the integrated shell feature for testing with reference to the first shell feature for testing to the n-th shell feature for testing and the first shell reliability for testing to the n-th shell reliability for testing corresponding to the first shell feature for testing to the n-th shell feature for testing.

In the instant case, as described above regarding the learning process, the cylindrical feature mapping device 2200 may output the integrated shell feature for testing by applying a weighted sum operation to the first shell feature for testing to the n-th shell feature for testing and the first shell reliability for testing to the n-th shell reliability for testing corresponding thereto.

Furthermore, the cylindrical transformer 2300 may update the integrated shell feature for testing by modifying the value of the main feature for testing with reference to the peripheral features for testing.

For example, the cylindrical transformer 2300 may output the first query corresponding to the main feature through the query network, output the first key and the first value corresponding to the peripheral feature through the neighbor network, and update the integrated shell feature by modifying the value of the main feature with reference to the first query, the first key, and the first value.

Furthermore, the cylindrical transformer 2300 may repeatedly perform a process for modifying peripheral features similar to the above-described main feature. That is, the cylindrical transformer 2300 may repeat the process of modifying the features corresponding to each image (view) by utilizing information related to the overlapping area between a plurality of images obtained through a plurality of image sensors, updating the integrated shell feature.

Furthermore, the decoder 2400 may output the predicted main depth information for testing corresponding to the main image for testing at a predetermined time point with reference to the updated integrated shell feature for testing, and output the predicted peripheral depth information for testing corresponding to the peripheral image at a predetermined time point.

FIG. 7 is a block diagram illustrating a computing system for executing a method of outputting depth information according to an exemplary embodiment of the present disclosure.

Referring to FIG. 7, a method of outputting depth information according to an exemplary embodiment of the present disclosure described above may be implemented through a computing system 100. The computing system 100 may include at least one processor 110, a memory 130, a user interface input device 140, a user interface output device 150, storage 160, and a network interface 170 connected through a system bus 120.

The processor 110 may be a central processing unit (CPU) or a semiconductor device that processes instructions stored in the memory 130 and/or the storage 160. The memory 130 and the storage 160 may include various types of volatile or non-volatile storage media. For example, the memory 130 may include a Read-Only Memory (ROM) 131 and a Random Access Memory (RAM) 132.

Accordingly, the processes of the method or algorithm described in relation to the exemplary embodiments of the present disclosure may be implemented directly by hardware executed by the processor 110, a software module, or a combination thereof. The software module may reside in a storage medium (that is, the memory 130 and/or the storage 160), such as a RAM, a flash memory, a ROM, an EPROM, an EEPROM, a register, a hard disk, solid state drive (SSD), a detachable disk, or a CD-ROM. The exemplary storage medium is coupled to the processor 110, and the processor 110 may read information from the storage medium and may write information in the storage medium. In another method, the storage medium may be integrated with the processor 110. The processor 110 and the storage medium may reside in an application specific integrated circuit (ASIC). The ASIC may reside in a user terminal. In another method, the processor and the storage medium may reside in the user terminal as an individual component.

According to an exemplary embodiment of the present disclosure, it is possible to provide a learning device and a learning method for estimating 3D spatial information based on a plurality of image sensors, and a test device and a test method using the same.

According to an exemplary embodiment of the present disclosure, it is possible to provide a learning device and a learning method for estimating omnidirectional 3D spatial information, and a test device and a test method using the same.

According to an exemplary embodiment of the present disclosure, it is possible to provide a learning device and a learning method for estimating accurate 3D spatial information by use of temporal information and spatial information, and a test device and a test method using the same.

In addition, various effects that are directly or indirectly understood through the present disclosure may be provided.

The control device may be at least one microprocessor operated by a predetermined program which may include a series of commands for carrying out the method included in the aforementioned various exemplary embodiments of the present disclosure.

The aforementioned invention can also be embodied as computer readable codes on a computer readable recording medium. The computer readable recording medium is any data storage device that can store data which may be thereafter read by a computer system and store and execute program instructions which may be thereafter read by a computer system. Examples of the computer readable recording medium include Hard Disk Drive (HDD), solid state disk (SSD), silicon disk drive (SDD), read-only memory (ROM), random-access memory (RAM), CD-ROMs, magnetic tapes, floppy discs, optical data storage devices, etc and implementation as carrier waves (e.g., transmission over the Internet). Examples of the program instruction include machine language code such as those generated by a compiler, as well as high-level language code which may be executed by a computer using an interpreter or the like.

In various exemplary embodiments of the present disclosure, each operation described above may be performed by a control device, and the control device may be configured by a plurality of control devices, or an integrated single control device.

In various exemplary embodiments of the present disclosure, the memory and the processor may be provided as one chip, or provided as separate chips.

In various exemplary embodiments of the present disclosure, the scope of the present disclosure includes software or machine-executable commands (e.g., an operating system, an application, firmware, a program, etc.) for enabling operations according to the methods of various embodiments to be executed on an apparatus or a computer, a non-transitory computer-readable medium including such software or commands stored thereon and executable on the apparatus or the computer.

In various exemplary embodiments of the present disclosure, the control device may be implemented in a form of hardware or software, or may be implemented in a combination of hardware and software.

Furthermore, the terms such as “unit”, “module”, etc. included in the specification mean units for processing at least one function or operation, which may be implemented by hardware, software, or a combination thereof.

In an exemplary embodiment of the present disclosure, the vehicle may be referred to as being based on a concept including various means of transportation. In some cases, the vehicle may be interpreted as being based on a concept including not only various means of land transportation, such as cars, motorcycles, trucks, and buses, that drive on roads but also various means of transportation such as airplanes, drones, ships, etc.

For convenience in explanation and accurate definition in the appended claims, the terms “upper”, “lower”, “inner”, “outer”, “up”, “down”, “upwards”, “downwards”, “front”, “rear”, “back”, “inside”, “outside”, “inwardly”, “outwardly”, “interior”, “exterior”, “internal”, “external”, “forwards”, and “backwards” are used to describe features of the exemplary embodiments with reference to the positions of such features as displayed in the figures. It will be further understood that the term “connect” or its derivatives refer both to direct and indirect connection.

The term “and/or” may include a combination of a plurality of related listed items or any of a plurality of related listed items. For example, “A and/or B” includes all three cases such as “A”, “B”, and “A and B”.

In the present specification, unless stated otherwise, a singular expression includes a plural expression unless the context clearly indicates otherwise.

In the exemplary embodiment of the present disclosure, it should be understood that a term such as “include” or “have” is directed to designate that the features, numbers, steps, operations, elements, parts, or combinations thereof described in the specification are present, and does not preclude the possibility of addition or presence of one or more other features, numbers, steps, operations, elements, parts, or combinations thereof.

According to an exemplary embodiment of the present disclosure, components may be combined with each other to be implemented as one, or some components may be omitted.

The foregoing descriptions of specific exemplary embodiments of the present disclosure have been presented for purposes of illustration and description. They are not intended to be exhaustive or to limit the present disclosure to the precise forms disclosed, and obviously many modifications and variations are possible in light of the above teachings. The exemplary embodiments were chosen and described in order to explain certain principles of the invention and their practical application, to enable others skilled in the art to make and utilize various exemplary embodiments of the present disclosure, as well as various alternatives and modifications thereof. It is intended that the scope of the present disclosure be defined by the Claims appended hereto and their equivalents.

What is claimed is:

1. A learning apparatus for estimating three-dimensional (3D) spatial information, the learning apparatus comprising:
a memory configured to store computer-executable instructions; and
at least one processor configured to access the memory and execute the instructions,
wherein the at least one processor is configured to:
output, through an encoder, a main encoding feature corresponding to a main image at a t-th time point obtained from a main image sensor, and output a peripheral encoding feature corresponding to at least one peripheral image which is obtained from a peripheral image sensor at the t-th time point and includes at least a part of a view angle overlapping the main image;
map, through a cylindrical feature mapping device, the main encoding feature and the peripheral encoding feature to a first cylindrical shell to a n-th cylindrical shell corresponding to a first depth value to a n-th depth value, and output an integrated shell feature including a main feature corresponding to the main image at the t-th time point and a peripheral feature corresponding to the peripheral image at the t-th time point with reference to a mapping result;
update the integrated shell feature by modifying a value of the main feature with reference to the peripheral feature through a cylindrical transformer;
output, through a decoder, predicted main depth information corresponding to the main image at the t-th time point with reference to the updated integrated shell feature; and
determine, through a parameter update device, a first loss with reference to the predicted main depth information and ground truth (GT) main depth information corresponding to the predicted main depth information, and update at least some of parameters of the encoder, the cylindrical feature mapping device, the cylindrical transformer, and the decoder by use of the first loss.

2. The learning apparatus of claim 1, wherein the at least one processor is further configured to additionally determine a second loss with reference to predicted main depth information corresponding to a main image at at least one of a (t+1)-th time point and a (t−1)-th time point and the predicted main depth information corresponding to the main image at the t-th time point, and update at least some of parameters of the encoder, the cylindrical feature mapping device, the cylindrical transformer, and the decoder by additionally using the second loss through the parameter update device.

3. The learning apparatus of claim 1,
wherein the cylindrical feature mapping device includes a feature output device and a reliability output device, and
wherein the at least one processor is further configured to:
output, through the feature output device, a first shell feature to a n-th shell feature corresponding to the first cylindrical shell to the n-th cylindrical shell by applying a feature extraction operation to a mapping result in the first cylindrical shell to the n-th cylindrical shell;
output, through the reliability output device, first shell reliability to n-th shell reliability corresponding to the first cylindrical shell to the n-th cylindrical shell by applying a reliability extraction operation to the mapping result in the first cylindrical shell to the n-th cylindrical shell; and
output, through the cylindrical feature mapping device, the integrated shell feature with reference to ‘the first shell feature to the n-th shell feature’ and ‘the first shell reliability to the n-th shell reliability corresponding to the first shell feature to the n-th shell feature’.

4. The learning apparatus of claim 3, wherein the at least one processor is further configured to output the integrated shell feature by applying a weighted sum operation to ‘the first shell feature to the n-th shell feature’ and ‘the first shell reliability to the n-th shell reliability corresponding to the first shell feature to the n-th shell feature’ through the cylindrical feature mapping device.

5. The learning apparatus of claim 1,
wherein the cylindrical transformer includes a query network and a neighbor network, and
wherein the at least one processor is further configured to:
output a first query corresponding to the main feature through the query network;
output a first key and a first value corresponding to the peripheral feature through the neighbor network; and
update the integrated shell feature by modifying the value of the main feature with reference to the first query, the first key, and the first value through the cylindrical transformer.

6. The learning apparatus of claim 5, wherein the at least one processor is further configured to:
additionally output a second query corresponding to the peripheral feature through the query network;
additionally output a second key and a second value corresponding to the main feature through the neighbor network; and
update the integrated shell feature by additionally modifying a value of the peripheral feature with additional reference to the second query, the second key, and the second value through the cylindrical transformer.

7. The learning apparatus of claim 6, wherein the at least one processor is further configured to:
additionally output, through the decoder, predicted peripheral depth information corresponding to the peripheral image at the t-th time point with reference to the updated integrated shell feature; and
determine the first loss with additional reference to the predicted peripheral depth information and GT peripheral depth information corresponding to the predicted peripheral depth information through the parameter update device.

8. The learning apparatus of claim 1, wherein the GT main depth information is generated using point cloud information obtained from a Light Detection and Ranging (LiDAR) sensor, an external parameter corresponding to the LiDAR sensor and the main image sensor, and an internal parameter corresponding to the main image sensor.

9. A test apparatus that utilizes a parameter updated by the learning apparatus of claim 1, the test apparatus including:
a memory configured to store computer-executable instructions; and
at least one processor configured to access the memory of the test apparatus and execute the instructions,
wherein the at least one processor of the test apparatus is configured to:
output, through an encoder of the test apparatus, a main encoding feature for testing corresponding to a main image for testing at a predetermined time point obtained from a main image sensor, and output a peripheral encoding feature for testing corresponding to at least one peripheral image for testing which is obtained from a peripheral image sensor at the predetermined time point and includes at least a part of a view angle overlapping the main image for testing;
map, through a cylindrical feature mapping device of the test apparatus, the main encoding feature for testing and the peripheral encoding feature for testing to a first cylindrical shell to a n-th cylindrical shell corresponding to a first depth value to a n-th depth value, and output an integrated shell feature for testing including a main feature for testing corresponding to the main image for testing and a peripheral feature for testing corresponding to the peripheral image for testing with reference to a mapping result;
update the integrated shell feature by modifying a value of the main feature for testing with reference to the peripheral feature for testing through a cylindrical transformer of the test apparatus; and
output, through a decoder of the test apparatus, predicted main depth information corresponding to the main image for testing with reference to the updated integrated shell feature for testing.

10. The test apparatus of claim 9, wherein the cylindrical feature mapping device includes a feature output device and a reliability output device, and
wherein the at least one processor of the test apparatus is configured to:
output, through the feature output device, a first shell feature for testing to a n-th shell feature for testing corresponding to the first cylindrical shell to the n-th cylindrical shell by applying a feature extraction operation to a mapping result in the first cylindrical shell to the n-th cylindrical shell;
output, through the reliability output device, first shell reliability for testing to n-th shell reliability for testing corresponding to the first cylindrical shell to the n-th cylindrical shell by applying a reliability extraction operation to the mapping result in the first cylindrical shell to the n-th cylindrical shell; and
output, through the cylindrical feature mapping device, the integrated shell feature for testing with reference to ‘the first shell feature for testing to the n-th shell feature for testing’ and ‘the first shell reliability for testing to the n-th shell reliability for testing corresponding to the first shell feature for testing to the n-th shell feature for testing’.

11. A learning method comprising:
outputting, by at least one processor, a main encoding feature corresponding to a main image at a t-th time point obtained from a main image sensor, and outputting a peripheral encoding feature corresponding to at least one peripheral image which is obtained from a peripheral image sensor at the t-th time point and includes at least a part of a view angle overlapping the main image;
mapping, by the at least one processor, the main encoding feature and the peripheral encoding feature to a first cylindrical shell to a n-th cylindrical shell corresponding to a first depth value to a n-th depth value, and outputting an integrated shell feature including a main feature corresponding to the main image at the t-th time point and a peripheral feature corresponding to the peripheral image at the t-th time point with reference to a mapping result;
updating, by the at least one processor, the integrated shell feature by modifying a value of the main feature with reference to the peripheral feature through a cylindrical transformer;
outputting, by the at least one processor, predicted main depth information corresponding to the main image at the t-th time point with reference to the updated integrated shell feature; and
determining, by the at least one processor, a first loss with reference to the predicted main depth information and ground truth (GT) main depth information corresponding to the predicted main depth information, and back-propagating the first loss.

12. The learning method of claim 11, wherein the back-propagating of the first loss includes:
additionally determining a second loss with reference to predicted main depth information corresponding to a main image at at least one of a (t+1)-th time point and a (t−1)-th time point and the predicted main depth information corresponding to the main image at the t-th time point, and additionally back-propagating the second loss.

13. The learning method of claim 11, wherein the outputting of the integrated shell feature includes:
outputting a first shell feature to a n-th shell feature corresponding to the first cylindrical shell to the n-th cylindrical shell by applying a feature extraction operation to a mapping result in the first cylindrical shell to the n-th cylindrical shell;
outputting first shell reliability to n-th shell reliability corresponding to the first cylindrical shell to the n-th cylindrical shell by applying a reliability extraction operation to the mapping result in the first cylindrical shell to the n-th cylindrical shell; and
outputting the integrated shell feature with reference to ‘the first shell feature to the n-th shell feature’ and ‘the first shell reliability to the n-th shell reliability corresponding to the first shell feature to the n-th shell feature’.

14. The learning method of claim 13, wherein the outputting of the integrated shell feature includes outputting the integrated shell feature by applying a weighted sum operation to ‘the first shell feature to the n-th shell feature’ and ‘the first shell reliability to the n-th shell reliability corresponding to the first shell feature to the n-th shell feature’.

15. The learning method of claim 11, wherein the updating of the integrated shell feature includes:
outputting a first query corresponding to the main feature;
outputting a first key and a first value corresponding to the peripheral feature; and
modifying the value of the main feature with reference to the first query, the first key, and the first value.

16. The learning method of claim 15, wherein the updating of the integrated shell feature includes:
outputting a second key and a second value corresponding to the main feature;
outputting a second query corresponding to the peripheral feature; and
modifying a value of the peripheral feature with reference to the second query, the second key, and the second value.

17. The learning method of claim 16,
wherein the outputting of the predicted main depth information includes additionally outputting predicted peripheral depth information corresponding to the peripheral image at the t-th time point with reference to the updated integrated shell feature, and
wherein the back-propagating of the first loss includes determining the first loss with additional reference to the predicted peripheral depth information and ground truth (GT) main depth information corresponding to the predicted peripheral depth information.
